(19) United States
(12) Patent Application Publication
(10) Pub. No.: US 2015/0137517 A1
(43) Pub. Date: May 21, 2015

(54) PIPE JOINT CONSTRUCTION

(71) Applicants: INOUE SUDARE CO., LTD., Kawachinagano-shi (JP); HIGASHIO MECH CO., LTD., Kawachinagano-shi, Osaka (JP)

(72) Inventor: Hiroshi Inoue, Kawachinagano (JP)

(73) Assignees: INOUE SUDARE CO., LTD., Kawachinagano-shi (JP); HIGASHIO MECH CO., LTD., Kawachinagano-shi, Osaka (JP)

(21) Appl. No.: 14/411,254

(22) PCT Filed: May 13, 2013
(86) PCT No.: PCT/JP2013/063279

§ 371 Date: Dec. 24, 2014

(30) Foreign Application Priority Data
Sep. 19, 2012 (JP) 2012-205647
Nov. 7, 2012 (JP) 2012-245025
Nov. 30, 2012 (JP) 2012-262696

(51) Int. Cl. F16L 19/065; F16L 19/10

(52) U.S. Cl. CPC F16L 19/065; F16L 19/10
USPC 285/382.7

(57) ABSTRACT

To provide a pipe joint construction with which swift and strong connection is possible without flare work on an end portion when a pipe composed of aluminum, a pipe joint construction provided with a joint main body 1 with a male screw and a cap nut 3 screwed to a male screw 2 of the joint main body 1 to connect an aluminum pipe 4, has a cylindrical compressed deformation sleeve 7, stored in an inner storing space 10 of the cap nut 3 and having a concave peripheral groove 9 on a peripheral face 8, in which a bottom thin wall portion 13 of concave groove, receiving compressing force F in axial direction from the joint main body 1 and the cap nut 3 when the cap nut 3 and the male screw 2 of the joint main body are screwed, is plastically deformed in a radial inner direction to bite into a peripheral face 14 of an inserted aluminum pipe 4 for stopping the aluminum pipe 4.

### FIELD OF THE INVENTION

This invention relates to a pipe joint construction.

### BACKGROUND ART

A flared joint is widely used as a kind of pipe joint (refer to Patent Document 1, for example).

Generally, as shown in FIG. 11, the flare joint has a construction in which a flared end portion 37, formed by plastic work of an end portion of a copper pipe in a tapered configuration enlarging in diameter, is held between a tapered face 31 of a joint main body 30 with a male screw 32 and a tapered face 34 of a cap nut 33 screwed to the male screw 32 of the joint main body 30, and sealed by press-fitting force.

However, it is eagerly desired that economical and light aluminum, not expensive and heavy copper, be used as the material of the pipe 35. When the pipe 35 is composed of aluminum, there is a disadvantage that flare work is difficult. Also in the case of copper pipe, there is a disadvantage that piping work efficiency is hindered because the flare work has to be conducted on working sites. And, although various pipe joint constructions are proposed to avoid these problems, there are also disadvantages that number of parts is large, parts of complicated shape are necessary, and much labor is required to assemble.

### PRIOR ART DOCUMENT

### Patent Document

Patent document 1 Japanese Patent Provisional Publication NO. 2005-42858.

### OUTLINE OF THE INVENTION

### Problems to be Solved by the Invention

Problems to be solved are; flare work on an aluminum pipe is difficult. Also in the case of copper pipe, working efficiency on piping work sites is hindered by the flare work. And, in various pipe joint constructions to avoid these problems, number of parts is large, parts of complicated shape are necessary, and much labor is required to assemble.

### Means for Solving the Problems

Therefore, in the pipe joint construction related to the present invention, a cylindrical compressed deformation sleeve, stored within a cap nut and having a concave peripheral groove on a peripheral face, is provided, a bottom thin wall portion of concave peripheral groove is formed on an inner portion of the concave peripheral groove in the compressed deformation sleeve, and, the bottom thin wall portion, receiving compressing force in axial direction by screwing the cap nut, is plastically deformed as to protrude to a radial inner direction with reducing a width dimension of the concave peripheral groove to bite into a peripheral face of an inserted aluminum pipe for stopping the aluminum pipe.

And, a cylindrical compressed deformation sleeve, stored within a cap nut and having a concave peripheral groove on a peripheral face, is provided, a bottom thin wall portion of concave peripheral groove is formed on an inner portion of the concave peripheral groove in the compressed deformation sleeve, and, the bottom thin wall portion, receiving compressing force in axial direction by screwing the cap nut, is plastically deformed as to protrude to a radial inner direction with reducing a width dimension of the concave peripheral groove to bite into a peripheral face of an inserted copper pipe for stopping the copper pipe.

And, an inner peripheral face of the compressed deformation sleeve is formed as a smooth peripheral face on an area corresponding to the bottom thin wall portion and its near portion.

And, a pipe joint construction, provided with a joint main body with a male screw and a cap nut screwed to a male screw of the joint main body to connect an aluminum pipe, has a cylindrical compressed deformation sleeve, stored in an inner storing space of the cap nut and having a concave peripheral groove on a peripheral face, in which a bottom thin wall portion of concave groove, receiving compressing force in axial direction from the joint main body and the cap nut when the cap nut and the male screw of the joint main body are screwed, is plastically deformed in a radial inner direction to bite into a peripheral face of an inserted aluminum pipe for stopping the aluminum pipe.

And, the compressed deformation sleeve is composed of aluminum or copper covered with aluminum.

And, a pipe joint construction, provided with a joint main body with a male screw and a cap nut screwed to a male screw of the joint main body to connect an copper pipe, has a cylindrical compressed deformation sleeve, stored in an inner storing space of the cap nut and having a concave peripheral groove on a peripheral face, in which a bottom thin wall portion of concave groove, receiving compressing force in axial direction from the joint main body and the cap nut when the cap nut and the male screw of the joint main body are screwed, is plastically deformed in a radial inner direction to bite into a peripheral face of an inserted copper pipe for stopping.

And, the compressed deformation sleeve is composed of copper. And, the concave groove is (preferably) U-shaped.

And, a sealing layer is preliminarily formed unitedly with the inner peripheral face of the compressed deformation sleeve to make tight seal state in the biting.

And, the compressed deformation sleeve has a sealing groove on the inner peripheral face and a sealing material is set into the sealing groove

And, it is also preferable to dispose a cylindrical cover member for promotion of relative rotational slide between an inner peripheral face of the cap nut and a peripheral face of the compressed deformation sleeve.

And, in the present invention, a cylindrical compressed deformation sleeve, stored within a cap nut and having a concave peripheral groove on a peripheral face, is provided, a bottom thin wall portion of concave peripheral groove is formed on an inner portion of the concave peripheral groove in the compressed deformation sleeve in a non-compressed state, and a small protrusion is formed on a sleeve inner peripheral face side of the bottom thin wall portion, the bottom thin wall portion, receiving compressing force in axial direction by screwing the cap nut, is plastically deformed as to protrude to a radial inner direction with reducing a width dimension of the concave peripheral groove to bite into a peripheral face of an inserted aluminum pipe for stopping the aluminum pipe, and, the small protrusion shows increasing function of anti drawing force to increase resistance against drawing.

And, in the present invention, a cylindrical compressed deformation sleeve, stored within a cap nut and having a concave peripheral groove on a peripheral face, is provided, a bottom thin wall portion of concave peripheral groove is formed on an inner portion of the concave peripheral groove in the compressed deformation sleeve in a non-compressed state, and a small protrusion is formed on a sleeve inner peripheral face side of the bottom thin wall portion, the bottom thin wall portion, receiving compressing force in axial direction by screwing the cap nut, is plastically deformed as to protrude to a radial inner direction with reducing a width dimension of the concave peripheral groove to bite into a peripheral face of an inserted copper pipe for stopping the copper pipe, and, the small protrusion shows increasing function of anti drawing force to increase resistance against drawing.

And, it is also preferable on some cases to form the small protrusion with plural notched portions as to be divided along an arc, and construct the small protrusion as to show preventing function of pipe rotation in the state biting into the peripheral face.

### Effects of the Invention

According to the pipe joint construction of the present invention, in both cases of aluminum pipe which is difficult to be plastically worked, and copper pipe which requires conventional flare work, it is unnecessary to conduct flare work on end portions, and working efficiency is high. Further, connection (piping) showing strong drawing force and sealability can be swiftly and easily conducted only with screwing the cap nut. And, the number of parts is small, the configurations of parts are simple, and the assembly is easy. Especially, the pipe joint construction is appropriate for piping for cooling media.

### BRIEF DESCRIPTION OF THE DRAWINGS

FIG. 1 A cross-sectional front view showing an unconnected state of a pipe of a first embodiment of the present invention.

FIG. 2 A cross-sectional front view showing a state in which connection is completed.

FIG. 3 A cross-sectional front view showing a compressed deformation sleeve.

FIG. 4 A cross-sectional front view showing a cap nut.

FIG. 5 A cross-sectional front view showing an unconnected state of a pipe of a second embodiment of the present invention.

FIG. 6 A cross-sectional front view showing a state in which connection is completed.

FIG. 7 A cross-sectional front view showing a compressed deformation sleeve.

FIG. 8 A cross-sectional front view showing an unconnected state of a pipe of a third embodiment of the present invention.

FIG. 9 A cross-sectional front view showing a state in which connection is completed.

FIG. 10 A cross-sectional front view showing a compressed deformation sleeve and a cover member.

FIG. 11 A cross-sectional front view showing an unconnected state of a pipe of a fourth embodiment of the present invention.

FIG. 12 A cross-sectional front view showing a state in which connection is completed.

FIG. 13 A cross-sectional front view showing a compressed deformation sleeve and a cover member.

FIG. 14 An explanatory view of function.

FIG. 15 A lateral cross-sectional view showing a modification.

FIG. 16 A cross-sectional front view showing a conventional example.

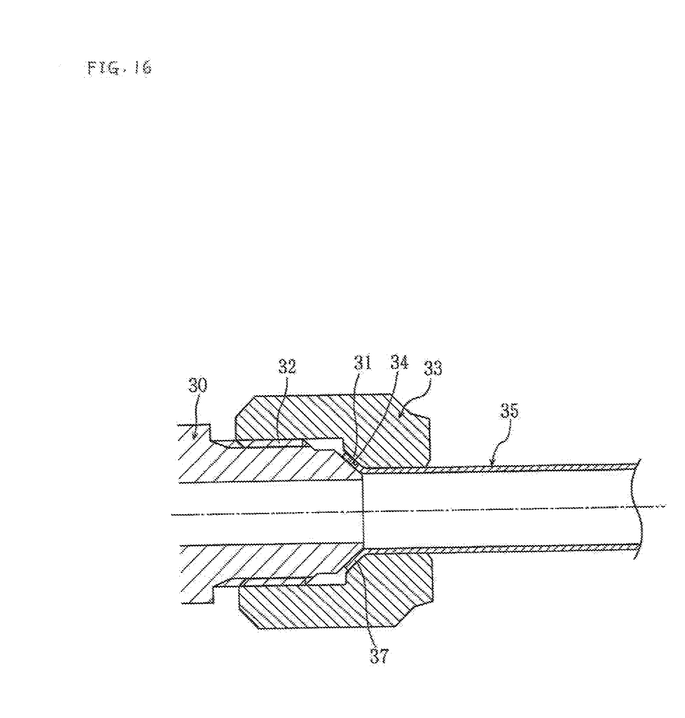

### EMBODIMENTS OF THE INVENTION

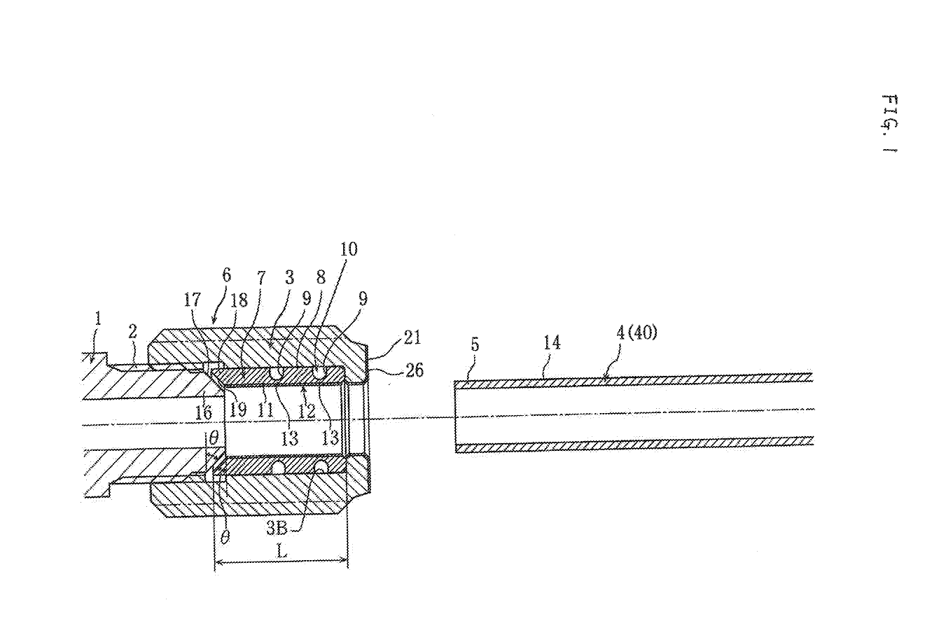

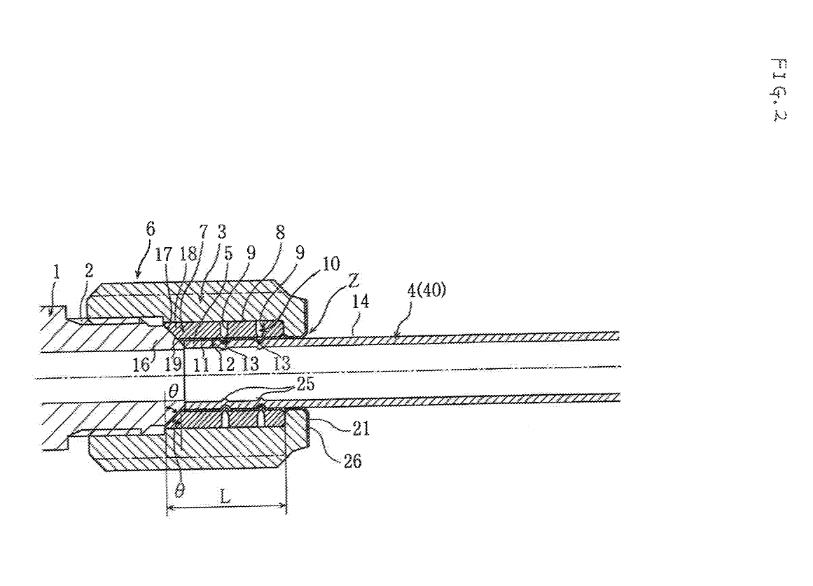

FIG. 1 shows a first embodiment of the present invention in a state in which an aluminum pipe is not connected. FIG. 2 shows a state in which connection is completed. This pipe joint construction is a pipe joint construction provided with a joint main body 1 with a male screw and a cap nut 3 screwed to a male screw 2 to connect an aluminum pipe 4, and a construction especially appropriate for piping of cooling media. The aluminum pipe 4 and a pipe joint 6 are connected without flare work on an end portion 5 of the aluminum pipe 4. The joint main body 1 and the cap nut 3 are, for example, composed of brass. Cooling media of air conditioner, etc. flows in the aluminum pipe 4 and the pipe joint 6.

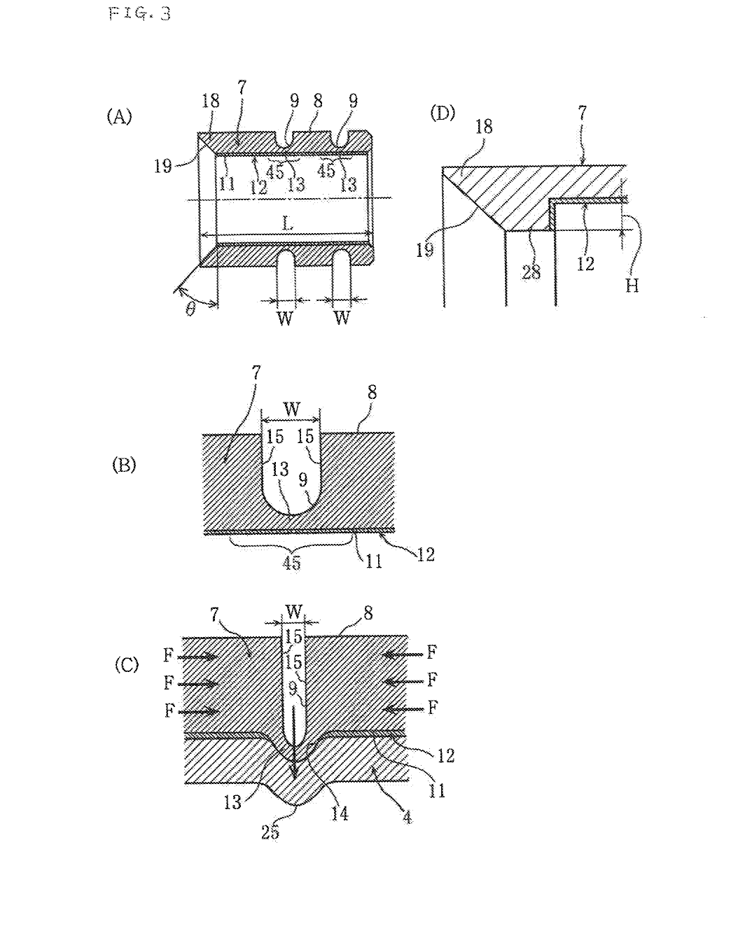

A compressed deformation sleeve 7 of aluminum is shown in FIG. 3(A). The compressed deformation sleeve 7 has two concave peripheral grooves 9 of U-shape on a peripheral face 8. As shown in FIG. 1 and FIG. 2, the compressed deformation sleeve 7 is stored in an inner storing space 10 of the cap nut 3.

As shown in FIG. 3(A) (B), the construction preliminarily has a sealing layer 12 unitedly with an inner peripheral face 11 of the compressed deformation sleeve 7. The sealing layer 12 is formed by painting fluorescent resin such as PTFE, for example. In the compressed deformation sleeve 7 in a free state in FIG. 3(B), a bottom thin wall portion 13 of concave groove, receiving compressing force (fastening force) F in axial direction from the joint main body 1 and the cap nut 3 when the cap nut 3 (refer to FIG. 1 and FIG. 2) and the male screw 2 of the joint main body 1 are screwed, is plastically deformed in the radial inner direction as shown in FIG. 3(C) to bite into the peripheral face 14 of the inserted aluminum pipe 4 for stopping the aluminum pipe 4 (having drawing resistance to prevent drawing out). In this case, as shown in FIG. 2 and FIG. 3(C), the inner peripheral face of the aluminum pipe 4 is also plastically deformed in a radial inner direction to form a small protrusion 25. A width dimension W of the concave peripheral groove 9 is reduced in the plastic deformation. And, the width dimension W may be 0 (namely, side faces 15 are press-fit, not shown in figures). And, a tight seal state is made by the sealing layer 12 in biting as in FIG. 3(C).

In the embodiment shown in FIG. 1, FIG. 2, and FIG. 3(A), the inner peripheral face 11 of the sleeve 7 is formed as a smooth peripheral face in non-compressed state. However, in the present invention, an area of the axial direction 2 times larger than the width dimension W of the concave peripheral groove 9 is defined as an area 45 corresponding to the bottom thin wall portion 13 and its near portion, and it is sufficient (to show anti drawing force) as far as the area 45 is formed into an approximately smooth peripheral face.

As shown in FIG. 1 and FIG. 2, the joint main body 1 has a tapered face 17 on an end portion 16 (for example, has the same configuration as that of a joint main body used for a flared pipe joint of JIS B8607). As shown in FIG. 3(A), and FIG. 1 and FIG. 2, the compressed deformation sleeve 7 has a tapered face 19 for press-fit sealing (of same inclination angle θ) corresponding to the tapered face 17 of the joint main body 1 on an end portion 18. The tapered face 17 and the tapered face 19 for press-fit sealing make tight sealing function by press fitting similarly to the conventional pipe joint construction of flared pipe joint.

FIG. 3(D) is an enlarged cross-sectional view of a principal portion showing a modification in which an inner brim portion 28 for reinforcement protrudes in the radial inner direction to prevent generation of excessive plastic deformation (in the radial outer direction) of the end portion 18 when the (above-mentioned) tapered face 17 and the tapered face 19. It is preferable to make a staged dimension H corresponding to an inner height of the inner brim portion 28 approximately same as the thickness dimension of the pipe 4 (40) in FIG. 1 and FIG. 2.

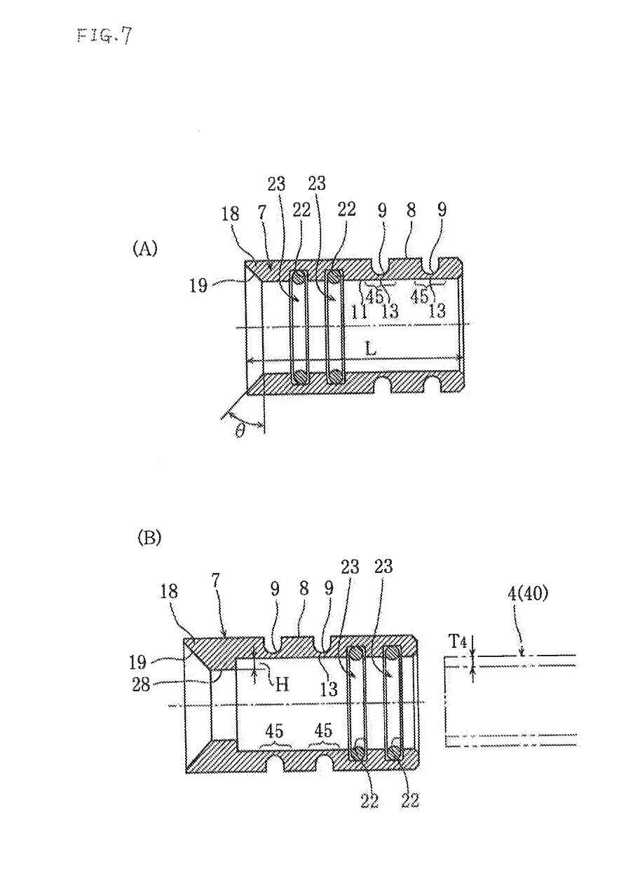

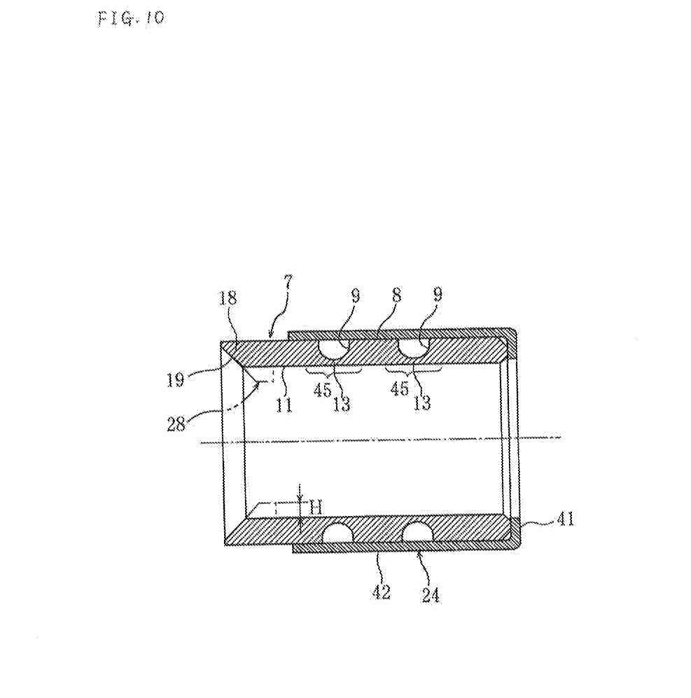

Further, in another embodiment shown in FIG. 10 described later, it is also preferable to make the inner brim portion 28 for reinforcement protrude as two-dot broken lines, and, inner brim portion 28 for reinforcement protrudes as in another embodiment shown in FIG. 7(B) and its staged dimension H is approximately same as the thickness dimension T₄ of the pipe 4 (40).

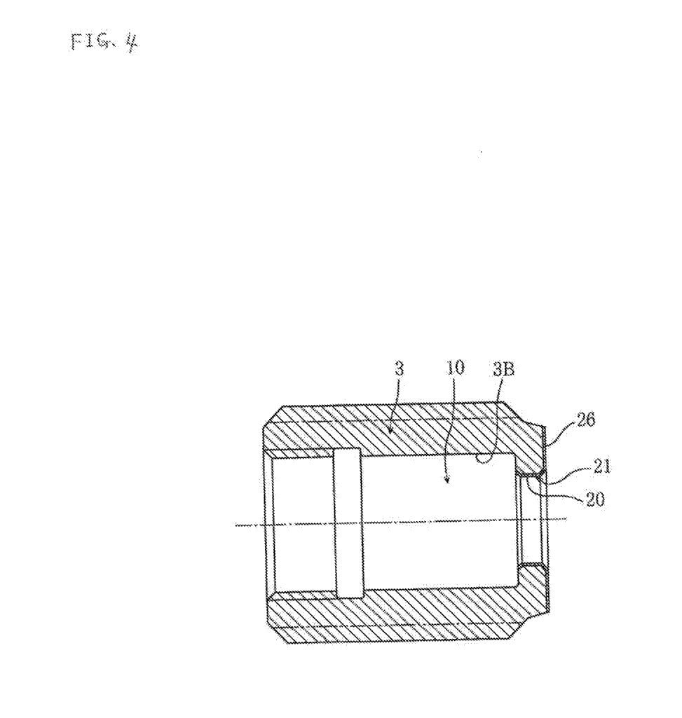

As shown in FIG. 4, at least an inner face receiving hole 20 and an outer end face 26 of the cap nut 3 are painted with insulating resin 21 to prevent electric corrosion. Even if the cap nut is composed of metal different from aluminum, such as brass, electric corrosion between different kinds of metals. The resin 21 is, for example, preferably composed of epoxy resin.

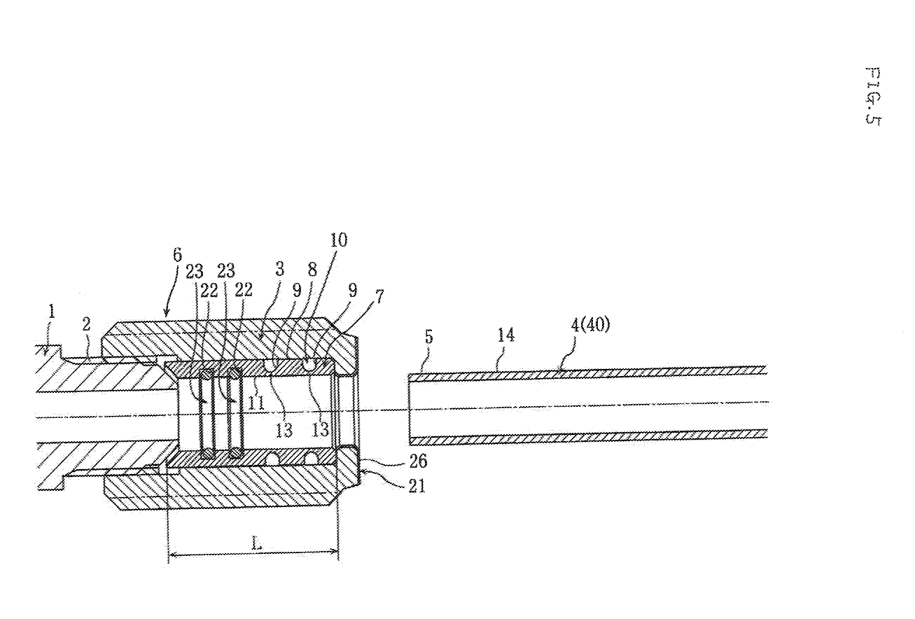

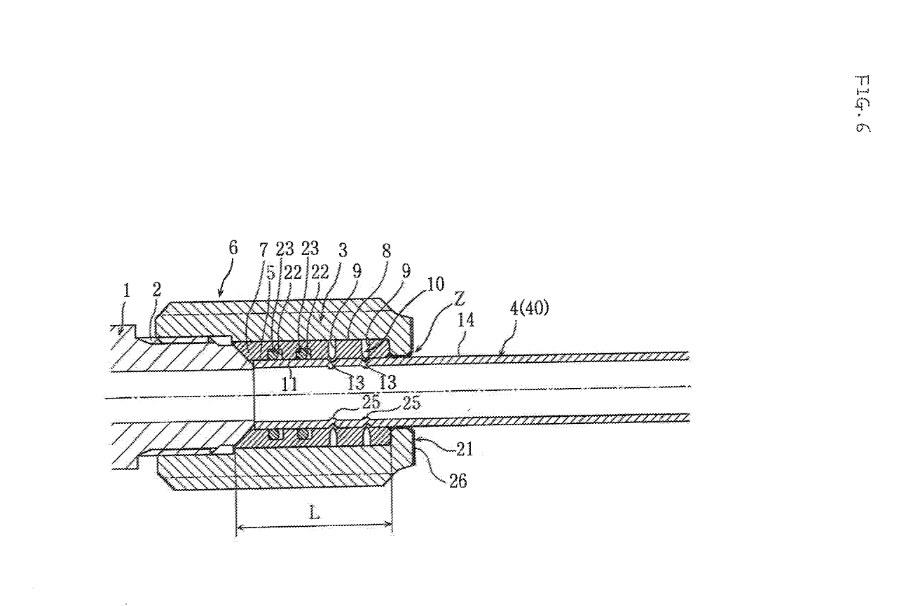

FIG. 5 shows a state before the aluminum pipe of a second embodiment of the present invention is connected. FIG. 6 shows a state in which the connection is completed. As shown in FIGS. 5 through 7, the compressed deformation sleeve 7 has two sealing grooves 22 on the inner peripheral face 11. A sealing material 23 such as an O-ring is set into the sealing groove 22. The inner peripheral face 11 of the compressed deformation sleeve 7 does not have a sealing layer (a length dimension L of the compressed deformation sleeve 7 in axial direction is longer than that of the first embodiment). Other constructions are same as that of the first embodiment.

FIG. 7(B) is a modification of FIG. 7(A), FIG. 5, and FIG. 6 in which the position of the sealing material 23 (sealing groove 22) and the position of the concave peripheral groove 9 are exchanged in the axial direction. With this construction as in FIG. 7(B), sealing function by press fitting of the bottom thin wall portion 13 of the concave peripheral groove to the peripheral face 14 of the pipe 4 (40) works in a first stage under the state of completed pipe connection (refer to FIG. 6), and certain sealing function can be made by the sealing material 23 (on the radial outer side) when the above sealing function is insufficient.

In the above-described first and second embodiments, although it is preferable to use aluminum for the sleeve 7 same as the material of the aluminum pipe 4, the sleeve 7 may be composed of copper covered with an aluminum layer on outer face (by plating, flame coating, etc.) when desired. That is to say, the latter can be chosen as far as electric corrosion is prevented.

Next, another embodiment is described. The material of the sleeve 7 is copper when a copper pipe 40 is used as the pipe in the first embodiment shown in FIG. 1 through FIG. 3. Explanation of the configuration and construction of the sleeve 7 is omitted because they are same as that in the case described with FIG. 1 through FIG. 3.

Next, still another embodiment is described. The material of the sleeve 7 is copper when a copper pipe 40 is used as the pipe in the second embodiment shown in FIG. 5 and FIG. 6. Explanation of the configuration and construction of the sleeve 7 is omitted because they are same as that in the case described with FIG. 5 and FIG. 6.

In the both embodiments, when the pipe is the copper pipe 40, the cap nut 3 shown in FIG. 4 may be made of copper, and the film of the resin 21 may be omitted in some cases.

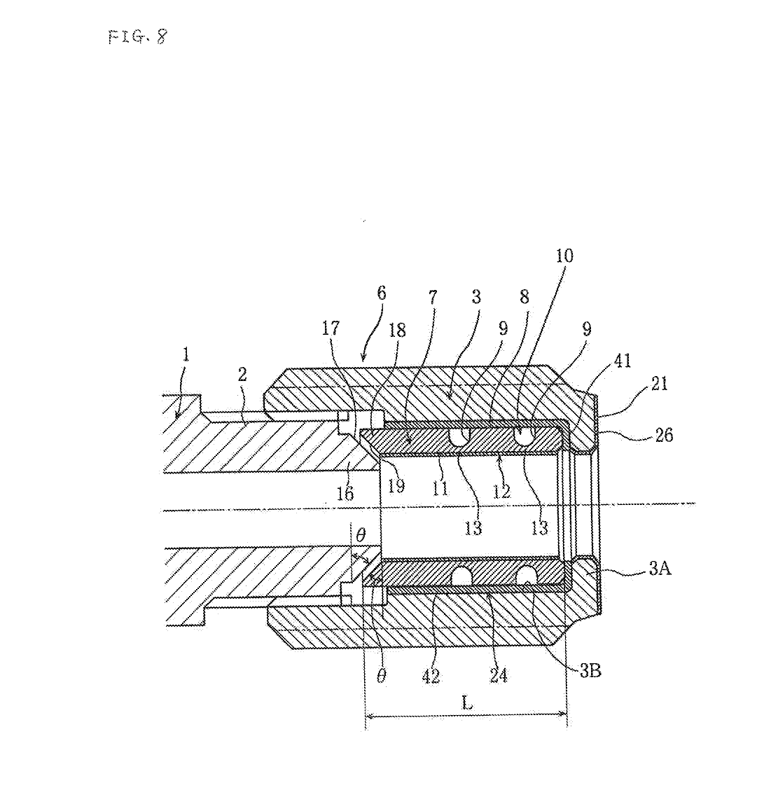

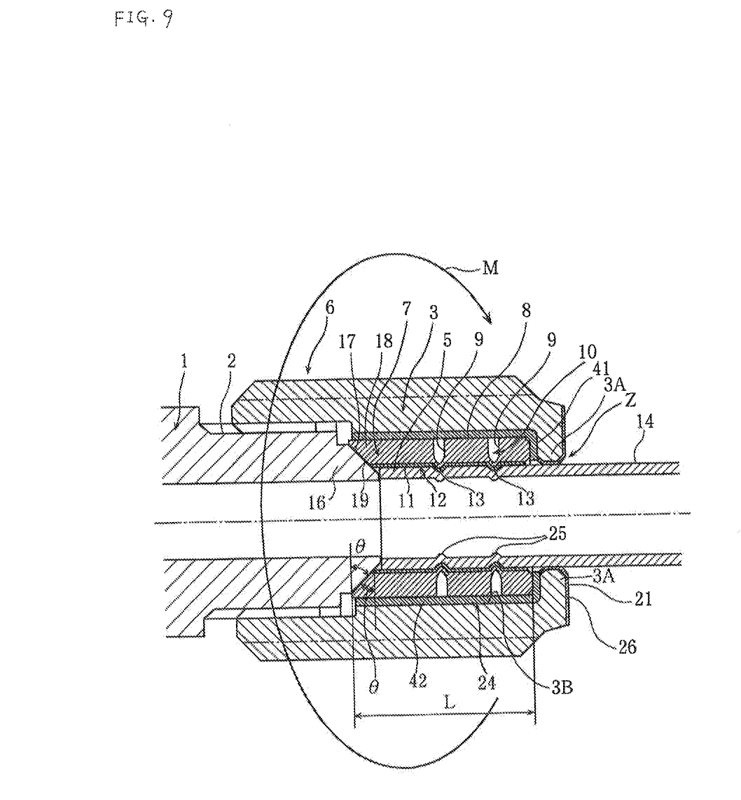

FIG. 8 shows a third embodiment of the present invention in a state in which an aluminum pipe is not connected. FIG. 9 shows a state in which connection is completed. In FIG. 8 through FIG. 10, a cover member 24 of hard metal such as stainless steel (or hard plastic) is mounted to the compressed deformation sleeve 7. That is to say, the cover member 24 is disposed (set) between the inner peripheral face 3B of the cap nut 3 and the peripheral face of the sleeve 7. The cover member 24 is composed of a cylinder portion 42 having a length dimension in axial direction slightly shorter than the length dimension L of the sleeve 7, and an inner brim portion 41 continuously connected to the outer end of the cylinder portion 42.

The cover member 24 is cylindrical as to reduce frictional resistance (resistance by press fitting) between the inner peripheral face 3B of the cap nut 3 and the peripheral face of the compressed deformation sleeve 7, and promote sliding (namely, to promote relative rotational sliding). Under the state shown in FIG. 2 and FIG. 6 in which the cover member 24 is not disposed, when the sleeve 7 is compressed and deformed in the axial direction along with screwing of the cap nut 3 (refer to an arrow M in FIG. 9), a deformation to increase the outer diameter of the sleeve 7 (in the radial outer direction) is generated, the sleeve 7 strongly press-fit to the inner peripheral face 3B of the cap nut 3 co rotates with the cap nut 3, and the aluminum pipe 4 (copper pipe 40) co rotates simultaneously, and torsion may be generated.

The cover member 24 is made of hard material such as stainless steel, and preferably, made of material of low friction coefficient to prevent the above described co rotation caused by strong press fitting (tight fitting) of the peripheral face of the sleeve 7 and the inner peripheral face of the cap nut 3, and the torsion of the aluminum pipe 4 (copper pipe 40). And, function to prevent electric corrosion of the cap nut 3 and the compressed deformation sleeve 7 is shown in some cases. Further, the above-mentioned inner brim portion 41 also shows a function to reduce the frictional resistance between the outer end face of the sleeve 7 and the inner brim portion 3A of the cap nut 3.

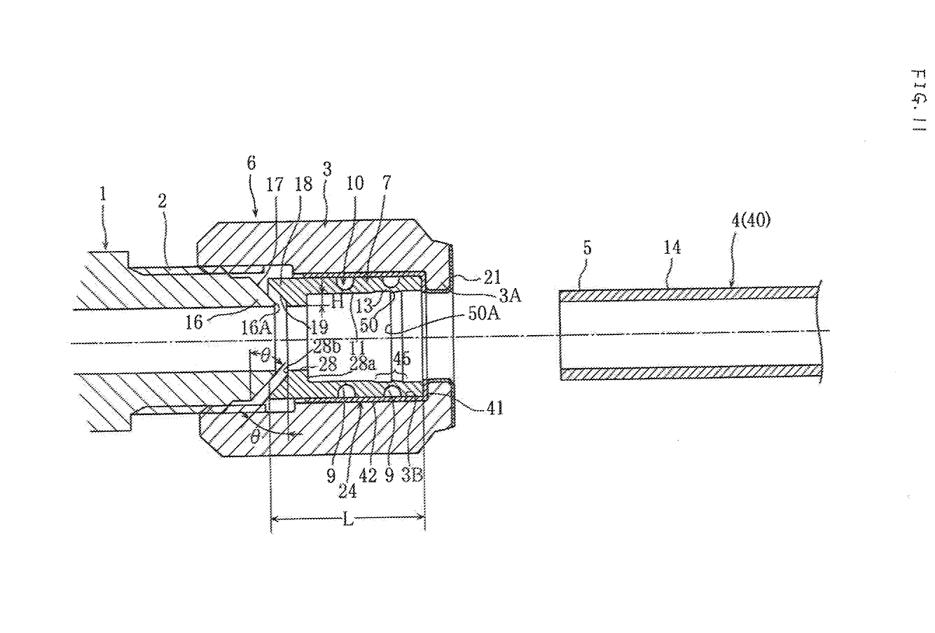

Next, FIG. 11 through FIG. 14 show a fourth embodiment of the present invention. Double explanation is omitted because the members of same marks are similarly constructed as in FIG. 1 through FIG. 10. So construction and function different from that of FIG. 1 through FIG. 10 are specifically described below.

A claw-shaped small protrusion 50 is formed on the sleeve inner peripheral face side on the bottom thin wall portion 13 on one of the two concave peripheral grooves 9 on the outer side of the pipe insertion side.

The small protrusion 50 has an approximately triangular cross-sectional configuration having a staged face 50A directed to the joint main body 1 side on a central portion of the bottom thin wall portion 13 in the axial direction to show increasing function of anti drawing force to increase resistance against drawing. That is to say, the bottom thin wall portion 13 receiving the compressing force F from the cap nut 3 is compressed and deformed, the small protrusion 50 deeply bites into the peripheral face of the aluminum pipe 4 (or the copper pipe 40) with the plastic deformation of U-shape of the bottom thin wall portion 13 to show the increasing function of anti drawing force to increase the anti drawing force of the bottom thin wall portion 13 further.

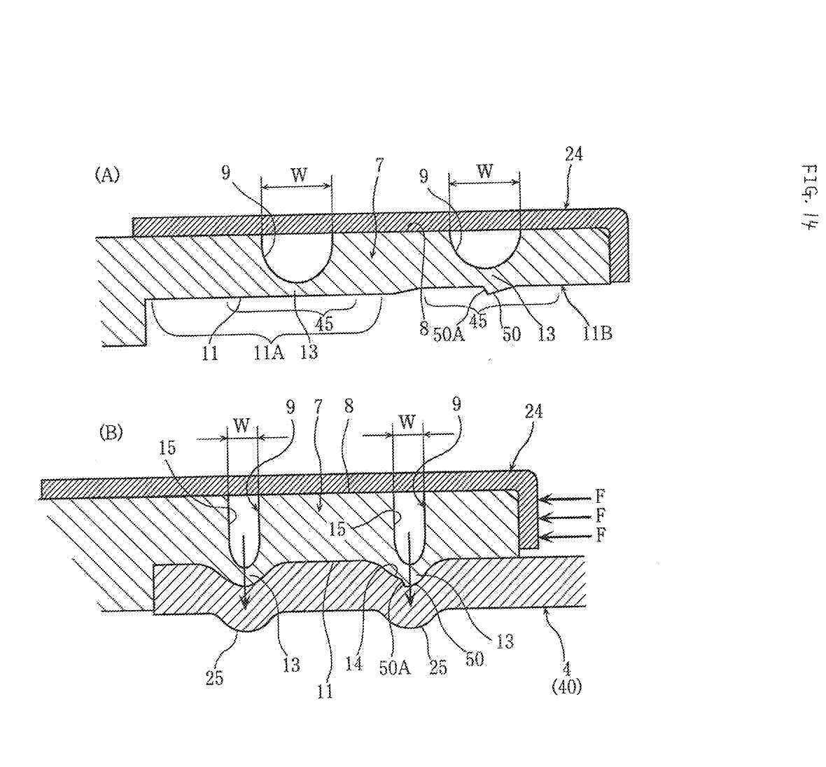

As shown in FIG. 14(B), while the bottom thin wall portion 13 on the left side (the joint main body 1 side) is curved in U-shape and biting into the peripheral face of the aluminum pipe 4 (or the copper pipe 40), the U-shaped curved portion as a base of the bottom thin wall portion 13 on the right side (outer side) and the small protrusion 50 on the top portion bite together to show the strong anti drawing force.

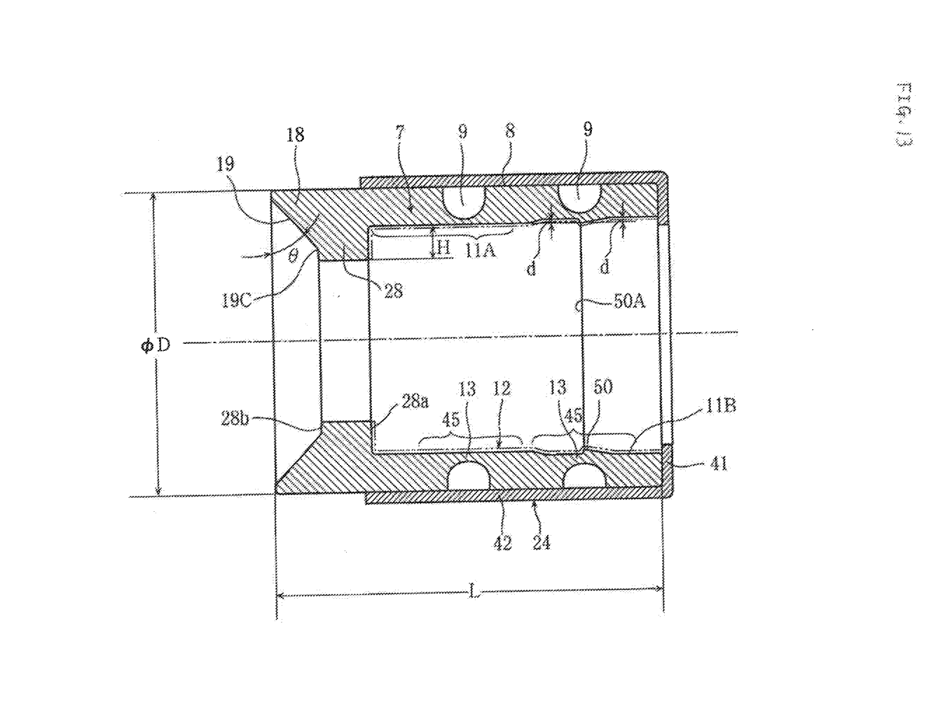

As shown in FIG. 13, it is desirable to form a large inner peripheral face portion 11B larger than the inner diameter dimension of a basic smooth inner peripheral face portion 11A for a small dimension 2d, the small protrusion 50 is disposed (formed) on a middle position of the large inner peripheral face portion 11B in the axial direction, and the inner diameter dimension of the small protrusion 50 is made the same as the inner diameter dimension of the smooth inner peripheral face portion 11A. That is to say, an escape of a small dimension d (refer to FIG. 13) is formed on both of the left and right sides (inner and outer sides in the axial direction) of the small protrusion 50.

In the present invention, the configuration of the sleeve 7 is called “approximately smooth” peripheral face configuration even when convexes and concaves of the small dimension d exist as shown in FIG. 13 under the non-compressed state of the sleeve 7. Therefore, it can be said that the sleeve 7 is formed into “approximately smooth” peripheral face configuration in the area 45 corresponding to the bottom thin wall portion 13 and its near portions also in the embodiment shown in FIG. 11 through FIG. 14. The width of the area 45 in the axial direction is defined as 2 times of the concave peripheral groove 9 in the non-compressed state. As described above, it can be said that the inner peripheral face 11 is an approximately smooth peripheral face in the area 45 of the bottom thin wall portions 13 and its near portions of the concave peripheral grooves 9 in the non-compressed state.

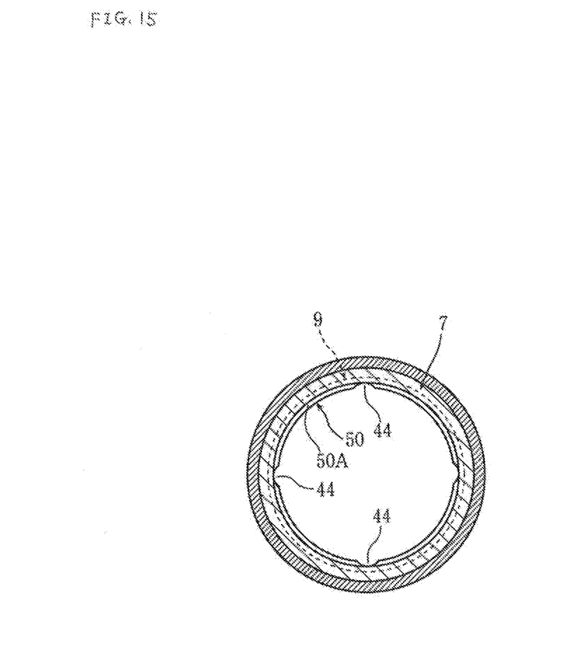

Next, in a modification shown in FIG. 15, a mark 44 shows a notched portion (non existence portion) of the small protrusion 50, the small protrusion 50 is formed with plural notched portions 44 as to be divided along an are. Therefore, the small protrusion 50 divided along the are shows preventing function of pipe rotation in the state biting into the peripheral face 14 of the aluminum pipe 4 (or the copper pipe 40). That is to say, in the biting state in FIG. 14(B), portions where the small protrusion 50 exists and portions where the small protrusion 50 does not exists are formed in turn on the positions in the peripheral direction, the pipe 4 or 40 and the sleeve 7 do not rotate relatively around the axis, and the rotation of the pipe 4 or 40 is certainly prevented. With this construction, the pipe 4 or 40 does not rotate even if rotational torque (external force) works on the pipe 4 or 40 after the piping is completed, and leakage of fluid between the biting thin wall portion 13 and the peripheral face 14 as shown in FIG. 14(B) can be prevented.

And, the number of the concave peripheral grooves 9 is most preferably 2 in the embodiments in FIG. 11 through FIG. 15. However, in FIG. 11 through FIG. 15, at least one of the concave peripheral grooves 9 is provided with the small protrusion 50 to show the increasing function of anti drawing force on the bottom thin wall portion 13.

To explain additionally, in each of the embodiments in FIG. 11 through FIG. 14, the concave peripheral groove 9 certainly has the small protrusion 50 on the bottom thin wall portion 13 in case of one concave peripheral groove 9, one or two concave peripheral grooves 9 have the small protrusion 50 on the bottom thin wall portion 13 in case of two concave peripheral grooves 9, and one, two, or three concave peripheral grooves 9 have the small protrusion 50 on the bottom thin wall portion 13 in case of three concave peripheral grooves 9. Further, the small protrusion 50 having the notched portion 44 as shown in FIG. 15 may be formed on the bottom thin wall portion 13 of the above-mentioned one or plural concave peripheral grooves 9.

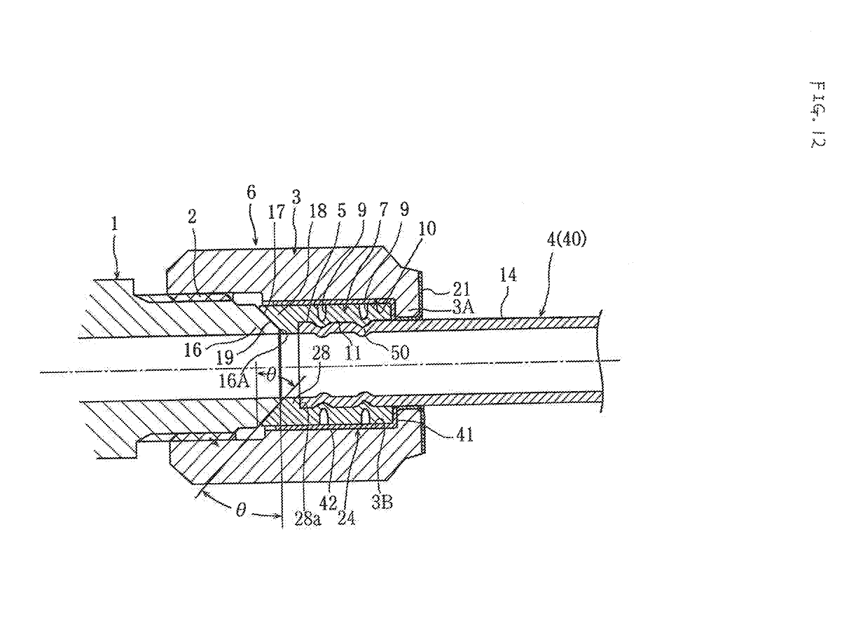

The above-described compressed deformation sleeve 7 of the present invention has a characteristic of being “short cylinder type”. “Short cylinder type” is defined as 0.5≦L/D≦3.0 when the outer diameter dimension is D and the length dimension is L. Therefore, one of the characteristics of the present invention is a construction in which the inner peripheral face of short cylinder type receives the compressing force F, the bottom thin wall portion 13 is plastically deformed as to protrude to the radial inner direction to bite into the peripheral face 14 of the inserted aluminum pipe 4 or the copper pipe 40 to form a stable U-shape for stopping, and, the small protrusion 50 shows increasing function of anti drawing force to increase resistance against drawing. The sleeve 7 of “short cylinder type” always holds a stable posture from the non-compressed state to the compressed state, and the local (small) bottom thin wall portion 13, keeping stable middle posture of plastic deformation, can conduct final plastic deformation to bite into the pipe as from FIG. 1 to FIG. 2, from FIG. 5 to FIG. 6, from FIG. 11 to FIG. 12, and from FIG. 14(A) to 14(B) further.

And, the concave peripheral groove 9, other than the U-shape having a large R shown in figures, may be a squared U-shape, and the inner portion of the groove may be protruding or V-shape as far as the concave peripheral groove 9 is U-shaped.

Next, in FIG. 11 through FIG. 13, the cross-sectional configuration of the inner brim portion 28 is different from that in FIG. 3(D) and FIG. 7(B), and this point is described.

A flat staged face at right angles with the axis having a staged dimension H (approximately equal to the thickness dimension of the pipe 4 (40)) corresponds to an inner end face 28a of the inner brim portion 28. And, an inclination line of the tapered face 19 of the inclination angle θ is straight (without bent portions) and forming a part of the outer end face of the inner brim portion 28, and an end portion 19C in the inner diameter direction of the inclination line is connected to a flat face portion 28b at right angles with the axis (refer to FIG. 13).

As described above, with the addition of the inner brim portion 28 to the sleeve 7, excessive plastic deformation to enlarge the diameter is prevented by reinforcing function with increased thickness of the end portion 18 of the sleeve 7 when the tapered face 19 is strongly (as in FIG. 12) press-fit to the tapered face 17. And, when the tapered faces 17 and 19 are press-fit more strongly by further screwing, the above-mentioned flat face portion 28b at right angles with the axis contacts a forth end face 16A of the joint main body 1 to prevent excessive screwing of the cap nut 3 by stopper function, and the excessive plastic deformation to enlarge the diameter is certainly prevented. That is to say, in figures, the inner brim portion 28 can stop the excessive plastic deformation to enlarge the diameter of the end portion 18 (the excessive screwing of the cap nut 3) by the increased thickness (cross-sectional area) and the stopper function by the flat face portion 28b at right angles with the axis which contacts the forth end face 16A.

The number of the U-shaped concave peripheral grooves 9 is most preferably 2. With one U-shaped concave peripheral groove 9, the bottom thin wall portion 13 tends to generate slip (deviation) on the aluminum pipe 4 in the plastic deformation, and it may be difficult to bite to the same position in the axis direction of the pipe, and, with three U-shaped concave peripheral grooves 9, unnecessary stress (inner stress) may remain between each of the U-shaped concave peripheral grooves 9. In the present invention, “aluminum” includes aluminum alloy, and “copper” includes copper system alloy.

In the present invention, which is modifiable, the cover member 24 may be disposed in the embodiment of FIG. 5 and FIG. 6 (not shown in figures). Further, the compressed deformation sleeve 7 may have one or three concave peripheral grooves 9 on the peripheral face 8. And, the compressed deformation sleeve 7 may have one sealing groove 22 on the inner peripheral face 11. And, the resin 21 may be painted on the whole surface of the cap nut 3.

As described above, with the present invention, strong connecting (piping) work can be swiftly conducted because the cylindrical compressed deformation sleeve 7, stored within the cap nut 3 and having the concave peripheral groove 9 on the peripheral face 8, is provided, the bottom thin wall portion 13 of concave peripheral groove is formed on an inner portion of the concave peripheral groove 9 in the compressed deformation sleeve 7, and, the bottom thin wall portion 13, receiving compressing force F in axial direction by screwing the cap nut 3, is plastically deformed as to protrude to the radial inner direction with reducing the width dimension W of the concave peripheral groove 9 to bite into the peripheral face 14 of the inserted aluminum pipe 4 for stopping the aluminum pipe 4. Further, it is unnecessary to conduct flare work on the end portion of the aluminum pipe 4 difficult to be plastically worked, and working efficiency is high. And, the number of parts is small, the configurations of parts are simple, and the assembly is easy.

And, strong connecting (piping) work can be swiftly conducted because the cylindrical compressed deformation sleeve 7, stored within the cap nut 3 and having the concave peripheral groove 9 on the peripheral face 8, is provided, the bottom thin wall portion 13 of concave peripheral groove is formed on an inner portion of the concave peripheral groove 9 in the compressed deformation sleeve 7, and, the bottom thin wall portion 13, receiving compressing force F in axial direction by screwing the cap nut 3, is plastically deformed as to protrude to the radial inner direction with reducing the width dimension W of the concave peripheral groove 9 to bite into the peripheral face 14 of the inserted copper pipe 40 for stopping the copper pipe 40. Further, it is unnecessary to conduct flare work on the end portion of the copper pipe 40, and working efficiency is high. And, the number of parts is small, the configurations of parts are simple, and the assembly is easy.

And, stable plastic deformation can be conducted on the peripheral face of the pipe 4 (40) because the inner peripheral face 11 of the compressed deformation sleeve 7 is formed as a smooth peripheral face on the area 45 corresponding to the bottom thin wall portion 13 and its near portion.

And, strong connecting (piping) work can be swiftly conducted because in a pipe joint construction (for cooling media, etc.) provided with the joint main body 1 with the male screw and the cap nut 3 screwed to the male screw 2 of the joint main body 1 to connect the aluminum pipe 4, the cylindrical compressed deformation sleeve 7, stored in the inner storing space 10 of the cap nut 3 and having the concave peripheral groove 9 on the peripheral face 8, in which the bottom thin wall portion 13 of concave groove, receiving compressing force F in axial direction from the joint main body 1 and the cap nut 3 when the cap nut 3 and the male screw 2 of the joint main body are screwed, is plastically deformed in the radial inner direction to bite into the peripheral face 14 of the inserted aluminum pipe 4 for stopping the aluminum pipe 4. Further, it is unnecessary to conduct flare work on the end portion of the aluminum pipe 4 difficult to be plastically worked, and working efficiency is high. And, the number of parts is small, the configurations of parts are simple, and the assembly is easy.

And, it is preferable that electric corrosion is not caused to the aluminum pipe 4 because the compressed deformation sleeve 7 is composed of aluminum or copper covered with aluminum.

And, it is not necessary to conduct flare work at all on the end portion of the conventional copper pipe, swift piping work can be conducted, working efficiency can be improved, and a strong construction of completed connection is made because in a pipe joint construction (for cooling media, etc.) provided with the joint main body 1 with the male screw and the cap nut 3 screwed to the male screw 2 of the joint main body 1 to connect the copper pipe 40, the cylindrical compressed deformation sleeve 7, stored in the inner storing space 10 of the cap nut 3 and having the concave peripheral groove 9 on the peripheral face 8, in which the bottom thin wall portion 13 of concave groove, receiving compressing force F in axial direction from the joint main body 1 and the cap nut 3 when the cap nut 3 and the male screw 2 of the joint main body are screwed, is plastically deformed in the radial inner direction to bite into the peripheral face 14 of the inserted copper pipe 40 for stopping the copper pipe 40. Further, the number of parts is small, and the configurations of parts are simple.

And, electric corrosion is not caused to the copper pipe 40 because the compressed deformation sleeve 7 is composed of copper.

And, sealability is good because the sealing layer 12 is preliminarily formed unitedly with the inner peripheral face 11 of the compressed deformation sleeve 7 to make tight seal state in the biting.

And, sealability can be improved and stabilized further because the compressed deformation sleeve 7 has the sealing groove 22 on the inner peripheral face 11 and the sealing material 23 is set into the sealing groove 22. Although rain, etc. tend to stay at the corner portion Z on the outer end face 26 of the cap nut 3, with covering of the insulating resin 21, electric corrosion between different kinds of metal can be prevented from being generated when the pipe is composed of aluminum and the joint main body 1 and the cap nut 3 are composed of metal different from aluminum such as brass.

The inner peripheral face 3B of the cap nut 3 and the peripheral face of the compressed deformation sleeve 7 lightly rotate, the problem of torsion of the aluminum pipe 4 or the copper pipe 40 is consequently solved, and the pipe connection work is certainly made easy because the cylindrical cover member 24 for promotion of relative rotational slide is disposed between the inner peripheral face 3B of the cap nut 3 and the peripheral face of the compressed deformation sleeve 7.

And, strong connecting (piping) work can be swiftly conducted because the cylindrical compressed deformation sleeve 7, stored within the cap nut 3 and having the concave peripheral groove 9 on the peripheral face 8, is provided, the bottom thin wall portion 13 of concave peripheral groove is formed on an inner portion of the concave peripheral groove 9 in the compressed deformation sleeve 7 in the non-compressed state, and the small protrusion 50 is formed on the sleeve inner peripheral face side of the bottom thin wall portion 13, the bottom thin wall portion 13, receiving compressing force F in axial direction by screwing the cap nut 3, is plastically deformed as to protrude to the radial inner direction with reducing the width dimension W of the concave peripheral groove 9 to bite into the peripheral face 14 of the inserted aluminum pipe 4 for stopping the aluminum pipe 4, and, the small protrusion 50 shows increasing function of anti drawing force to increase resistance against drawing. Further, it is unnecessary to conduct flare work on the end portion of the aluminum pipe 4, and working efficiency is high. And, the number of parts is small, the configurations of parts are simple, and the assembly is easy. Especially, the anti drawing force is remarkably strong for the co-working of the bottom thin wall portion 13 and the small protrusion 50.

And, it is not necessary to conduct flare work at all on the end portion of the conventional copper pipe, swift piping work can be conducted, working efficiency can be improved, and a strong construction of completed connection is made because the cylindrical compressed deformation sleeve 7, stored within the cap nut 3 and having the concave peripheral groove 9 on the peripheral face 8, is provided, the bottom thin wall portion 13 of concave peripheral groove is formed on an inner portion of the concave peripheral groove 9 in the compressed deformation sleeve 7 in the non-compressed state, and the small protrusion 50 is formed on the sleeve inner peripheral face side of the bottom thin wall portion 13, the bottom thin wall portion 13, receiving compressing force F in axial direction by screwing the cap nut 3, is plastically deformed as to protrude to the radial inner direction with reducing the width dimension W of the concave peripheral groove 9 to bite into the peripheral face 14 of the inserted copper pipe 40 for stopping the copper pipe 40, and, the small protrusion 50 shows increasing function of anti drawing force to increase resistance against drawing. Further, the number of parts is small, and the configurations of parts are simple. Especially, the anti drawing force is remarkably strong for the co-working of the bottom thin wall portion 13 and the small protrusion 50.

And, the rotation of the pipe 4 or 40 is prevented simultaneously with the plastic deformation of the sleeve 7 receiving the compressing force F in the axial direction, the sealability is prevented from decreasing, and excellent sealing function is shown for a long period of time because the small protrusion 50 is formed with plural notched portions 44 as to be divided along an arc, and the small protrusion 50 is constructed as to show preventing function of pipe rotation in the state biting into the peripheral face 14.

### EXPLANATION OF THE MARKS

1 A joint main body (with a male screw)
2 A male screw
3 A cap nut
4 An aluminum pipe
7 A compressed deformation sleeve
8 A peripheral face
9 A concave peripheral groove
10 An inner storing space
11 An inner peripheral face
12 A sealing layer
13 A bottom thin wall portion
14 A peripheral face
22 A sealing groove
23 A sealing material
24 A cover member
40 A copper pipe
44 A notched portion
50 An area
50 A small protrusion
F Compressing force (fastening force)
W A width dimension

1: A pipe joint construction characterized by that:
a cylindrical compressed deformation sleeve (7), stored within a cap nut (3) and having a concave peripheral groove (9) on a peripheral face (8), is provided;
a bottom thin wall portion (13) of concave peripheral groove is formed on an inner portion of the concave peripheral groove (9) in the compressed deformation sleeve (7); and
the bottom thin wall portion (13), receiving compressing force (F) in axial direction by screwing the cap nut (3), is plastically deformed as to protrude to a radial inner direction with reducing a width dimension (W) of the concave peripheral groove (9) to bite into a peripheral face (14) of an inserted aluminum pipe (4) for stopping the aluminum pipe (4).

2: A pipe joint construction characterized by that:
a cylindrical compressed deformation sleeve (7), stored within a cap nut (3) and having a concave peripheral groove (9) on a peripheral face (8), is provided;
a bottom thin wall portion (13) of concave peripheral groove is formed on an inner portion of the concave peripheral groove (9) in the compressed deformation sleeve (7); and
the bottom thin wall portion (13), receiving compressing force (F) in axial direction by screwing the cap nut (3), is plastically deformed as to protrude to a radial inner direction with reducing a width dimension (W) of the concave peripheral groove (9) to bite into a peripheral face (14) of an inserted copper pipe (40) for stopping the copper pipe (40).

3: The pipe joint construction as set forth in claim 1, wherein an inner peripheral face (11) of the compressed deformation sleeve (7) is formed as a smooth peripheral face on an area (45) corresponding to the bottom thin wall portion (13) and its near portion.

4: A pipe joint construction provided with a joint main body (1) with a male screw and a cap nut (3) screwed to a male screw (2) of the joint main body (1) to connect an aluminum pipe (4), characterized by a cylindrical compressed deformation sleeve (7), stored in an inner storing space (10) of the cap nut (3) and having a concave peripheral groove (9) on a peripheral face (8), in which a bottom thin wall portion (13) of concave groove, receiving compressing force (F) in axial direction from the joint main body (1) and the cap nut (3) when the cap nut (3) and the male screw (2) of the joint main body (1) are screwed, is plastically deformed in a radial inner direction to bite into a peripheral face (14) of an inserted aluminum pipe (4) for stopping the aluminum pipe (4).

5: The pipe joint construction as set forth in claim 4, wherein the compressed deformation sleeve (7) is composed of aluminum or copper covered with aluminum.

6: A pipe joint construction provided with a joint main body (1) with a male screw and a cap nut (3) screwed to a male screw (2) of the joint main body (1) to connect an copper pipe (40), characterized by a cylindrical compressed deformation sleeve (7), stored in an inner storing space (10) of the cap nut (3) and having a concave peripheral groove (9) on a peripheral face (8), in which a bottom thin wall portion (13) of concave groove, receiving compressing force (F) in axial direction from the joint main body (1) and the cap nut (3) when the cap nut (3) and the male screw (2) of the joint main body (1) are screwed, is plastically deformed in a radial inner direction to bite into a peripheral face (14) of an inserted copper pipe (40) for stopping.

7: The pipe joint construction as set forth in claim 6, wherein the compressed deformation sleeve (7) is composed of copper.

8: The pipe joint construction as set forth in claim 1, wherein the concave groove (9) is U-shaped.

9: The pipe joint construction as set forth in claim 1, wherein a sealing layer (12) is preliminarily formed unitedly with the inner peripheral face (11) of the compressed deformation sleeve (7) to make tight seal state in the biting.

10: The pipe joint construction as set forth in claim 1, wherein the compressed deformation sleeve (7) has a sealing groove (22) on the inner peripheral face (11) and a sealing material (23) is set into the sealing groove (22).

11: The pipe joint construction as set forth in claim 1, wherein a cylindrical cover member (24) for promotion of relative rotational slide is disposed between an inner peripheral face (3B) of the cap nut (3) and a peripheral face of the compressed deformation sleeve (7).

12: A pipe joint construction characterized by that:
a cylindrical compressed deformation sleeve (7), stored within a cap nut (3) and having a concave peripheral groove (9) on a peripheral face (8), is provided;
a bottom thin wall portion (13) of concave peripheral groove is formed on an inner portion of the concave peripheral groove (9) in the compressed deformation sleeve (7) in a non-compressed state, and a small protrusion (50) is formed on a sleeve inner peripheral face side of the bottom thin wall portion (13);
the bottom thin wall portion (13), receiving compressing force (F) in axial direction by screwing the cap nut (3), is plastically deformed as to protrude to a radial inner direction with reducing a width dimension (W) of the concave peripheral groove (9) to bite into a peripheral face (14) of an inserted aluminum pipe (4) for stopping the aluminum pipe (4); and
the small protrusion (50) shows increasing function of anti drawing force to increase resistance against drawing.

13: A pipe joint construction characterized by that:
a cylindrical compressed deformation sleeve (7), stored within a cap nut (3) and having a concave peripheral groove (9) on a peripheral face (8), is provided;
a bottom thin wall portion (13) of concave peripheral groove is formed on an inner portion of the concave peripheral groove (9) in the compressed deformation sleeve (7) in a non-compressed state, and a small protrusion (50) is formed on a sleeve inner peripheral face side of the bottom thin wall portion (13);
the bottom thin wall portion (13), receiving compressing force (F) in axial direction by screwing the cap nut (3), is plastically deformed as to protrude to a radial inner direction with reducing a width dimension (W) of the concave peripheral groove (9) to bite into a peripheral face (14) of an inserted copper pipe (40) for stopping the copper pipe (40); and
the small protrusion (50) shows increasing function of anti drawing force to increase resistance against drawing.

14: The pipe joint construction as set forth in claim 12, wherein the small protrusion (50) is formed with plural notched portions (44) as to be divided along an arc, and the small protrusion (50) is constructed as to show preventing function of pipe rotation in the state biting into the peripheral face (14).

15: The pipe joint construction as set forth in claim 2, wherein an inner peripheral face (11) of the compressed deformation sleeve (7) is formed as a smooth peripheral face on an area (45) corresponding to the bottom thin wall portion (13) and its near portion.

16: The pipe joint construction as set forth in claim 2, wherein the concave groove (9) is U-shaped.

17: The pipe joint construction as set forth in claim 4, wherein the concave groove (9) is U-shaped.

18: The pipe joint construction as set forth in claim 6, wherein the concave groove (9) is U-shaped.

19: The pipe joint construction as set forth in claim 2, wherein a sealing layer (12) is preliminarily formed unitedly with the inner peripheral face (11) of the compressed deformation sleeve (7) to make tight seal state in the biting.

20: The pipe joint construction as set forth in claim 4, wherein a sealing layer (12) is preliminarily formed unitedly with the inner peripheral face (11) of the compressed deformation sleeve (7) to make tight seal state in the biting.

21: The pipe joint construction as set forth in claim 6, wherein a sealing layer (12) is preliminarily formed unitedly with the inner peripheral face (11) of the compressed deformation sleeve (7) to make tight seal state in the biting.

22: The pipe joint construction as set forth in claim 2, wherein the compressed deformation sleeve (7) has a sealing groove (22) on the inner peripheral face (11) and a sealing material (23) is set into the sealing groove (22).

23: The pipe joint construction as set forth in claim 4, wherein the compressed deformation sleeve (7) has a sealing groove (22) on the inner peripheral face (11) and a sealing material (23) is set into the sealing groove (22).

24: The pipe joint construction as set forth in claim 6, wherein the compressed deformation sleeve (7) has a sealing groove (22) on the inner peripheral face (11) and a sealing material (23) is set into the sealing groove (22).

25: The pipe joint construction as set forth in claim 2, wherein a cylindrical cover member (24) for promotion of relative rotational slide is disposed between an inner peripheral face (3B) of the cap nut (3) and a peripheral face of the compressed deformation sleeve (7).

26: The pipe joint construction as set forth in claim 4, wherein a cylindrical cover member (24) for promotion of relative rotational slide is disposed between an inner peripheral face (3B) of the cap nut (3) and a peripheral face of the compressed deformation sleeve (7).

27: The pipe joint construction as set forth in claim 6, wherein a cylindrical cover member (24) for promotion of relative rotational slide is disposed between an inner peripheral face (3B) of the cap nut (3) and a peripheral face of the compressed deformation sleeve (7).

28: The pipe joint construction as set forth in claim 13, wherein the small protrusion (50) is formed with plural notched portions (44) as to be divided along an are, and the small protrusion (50) is constructed as to show preventing function of pipe rotation in the state biting into the peripheral face (14).
